(19) United States
(12) Patent Application Publication
(10) Pub. No.: US 2015/0356081 A1
(43) Pub. Date: Dec. 10, 2015

(54) ADVANCED CAMERA MANAGEMENT FUNCTION

(71) Applicant: GrandiOs Technologies, LLC, Wilmington, DE (US)

(72) Inventor: John Cronin, Bonita Springs, FL (US)

(21) Appl. No.: 14/631,687

(22) Filed: Feb. 25, 2015

Related U.S. Application Data
(60) Provisional application No. 62/007,866, filed on Jun. 4, 2014.

(51) Int. Cl. G06F 17/30; G06K 9/46; G06K 9/62

(52) U.S. Cl. CPC G06F 17/3028; G06K 9/6215; G06K 9/46

(57) ABSTRACT

Systems and methods are provided for managing advanced camera functions on an electronic device according to settings of management control functions on the electronic device. In certain instances, when an image is acquired by a camera in an electronic device, rich metadata associated with the image and the image itself may be stored in one or more data repositories. Image and metadata collected may be analyzed by a local or a remote software application program. Metadata from one image may be used to identify other images of interest, analyzed for trends, or used in a simulator to re-create an experience.

### CROSS-REFERENCE TO RELATED APPLICATION

The present application claims the priority benefit of U.S. provisional application No. 62/007,866 filed Jun. 4, 2014 and entitled “Advanced Camera Management Function,” the disclosure of which is incorporated herein by reference.

### BACKGROUND OF THE INVENTION

1. Field of the Invention

This invention relates to an advanced camera management system in a mobile electronic device. More specifically, the invention relates to collecting rich metadata that is associated with an image received by a mobile electronic device.

2. Description of the Related Art

It is well known that smartphones (e.g., iPhones, Android phones, and Samsung phones) have cameras in them. Frequently, these devices have a front camera and a back camera. It is also well known that the camera in these devices include some level of control in the operating system. For example, current smartphone operating system settings include turning the flash on or off when a photo is taken. Furthermore, there are many applications in the Apple App Store and in the Google Play Store that perform simple photo editing functions, (e.g., removing red eye or adding a frame). Information (e.g., metadata) stored with images in current smartphones is limited to the time and date that the image was captured, as well as the size of the image file.

Since information stored with images in current smartphones is extremely limited, there is an opportunity to provide system and methods that use other types of information collected at the time a photo or video is taken to be used in new ways.

### SUMMARY OF THE CLAIMED INVENTION

Embodiments of the present invention provide for systems and methods of managing advanced camera functions on an electronic device according to settings of management control functions on the electronic device. In certain instances, when an image is acquired by a camera in an electronic device, rich metadata associated with the image and the image itself may be stored in one or more data repositories. Image and metadata collected may be analyzed by a local or a remote software application program. Metadata from one image may be used to identify other images of interest, analyzed for trends, or used in a simulator to re-create an experience.

Embodiments of the present invention may include methods for advanced camera functions. Such methods may include displaying a user interface locally on the display of an electronic device, receiving a selection of a camera management control function from the user through the user interface of the electronic device, acquiring an image by a camera in the mobile electronic device, collecting metadata associated with the image, storing the image and the metadata associated with the image, and providing the image and metadata associated with the image to an application program for analysis.

Additional embodiments of present invention may include a non-transitory computer readable medium executable on a processor that may be implemented in a system consistent with certain embodiments of the invention.

### BRIEF DESCRIPTION OF THE DRAWINGS

FIG. 1 illustrates an exemplary network environment in which a system for advanced camera management may be implemented.

FIG. 2 is a flowchart illustrating an exemplary method for advanced camera management.

FIG. 3 illustrates exemplary camera center settings of a mobile device that may be used in a system for advanced camera management.

FIG. 4 is a chart illustrating exemplary metadata camera controls that may be implemented via a system for advanced camera management.

FIG. 5 illustrates an exemplary video sub-user interface and an exemplary real-time sub-user interface that may be used in a system for advanced camera management.

FIG. 6 illustrates an exemplary allow invites sub-user interface and an exemplary state of handheld sub-user interface that may be used in a system for advanced camera management.

FIG. 7 illustrates an exemplary save data locally sub-user interface and an exemplary camera settings sub-user interface that may be used in a system for advanced camera management.

FIG. 8 illustrates an exemplary security sub-user interface and an exemplary remote sub-user interface that may be used in a system for advanced camera management.

FIG. 9 illustrates a mobile device architecture that may be utilized to implement the various features and processes described herein.

### DETAILED DESCRIPTION

Embodiments of the present invention provide for systems and methods of managing advanced camera functions on an electronic device according to settings of management control functions on the electronic device. In certain instances, when an image is acquired by a camera in an electronic device, rich metadata associated with the image and the image itself may be stored in one or more data repositories. Image and metadata collected may be analyzed by a local or a remote software application program. Metadata from one image may be used to identify other images of interest, analyzed for trends, or used in a simulator to re-create an experience.

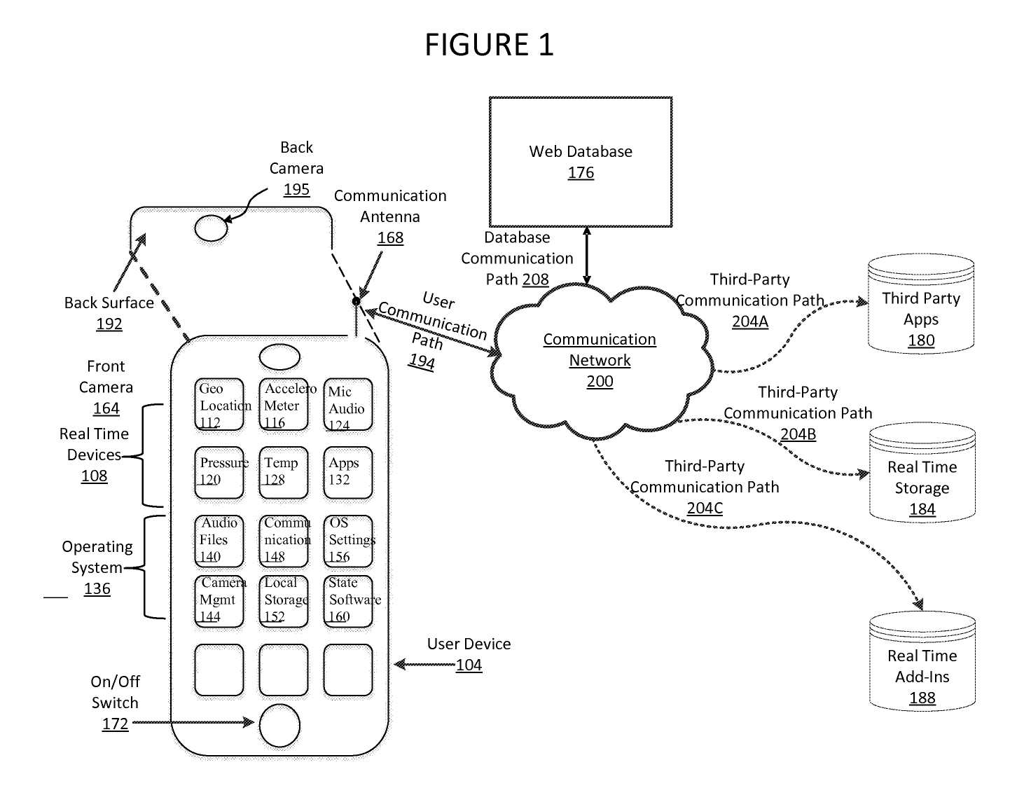

FIG. 1 illustrates an exemplary network environment 100 in which a system for advanced camera management may be implemented. Network environment 100 may include a user device 104, the cloud or Internet 200, a web database 176, third party applications 180, real-time storage 184, and real-time add-ins 188. Communications to or from the user device 104 are transmitted through communication antenna 168, and user communication path 194 to the cloud or Internet 200. In certain instances, WEB database 176 receives and transmits communications through the cloud or Internet 200 using database communication path 208. Third party communication paths 204A, 204B, and 204C communicate between the cloud or Internet and third party applications 180, real-time storage 184, and real-time add-ins 188.

Users may use any number of different electronic user devices 104, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network 200. User devices 104 may also be configured to access data from other storage media, such as memory cards or disk drives as may be appropriate in the case of downloaded services. User device 104 may include standard hardware computing components such as network and media interfaces, non-transitory computer-readable storage (memory), and processors for executing instructions that may be stored in memory.

As illustrated, user device 104 may include real-time devices 108 (e.g., geo-location 112, accelerometer 116, audio microphone 124, pressure 120, temperature 128, apps 132) and operating system 136, which may include audio files 140, camera management 144, communication 148, local storage 152, operating system settings 156, and state software 160. User device 104 may further include a front-facing camera 164, communication antenna 168, on/off (or home) button 172, and a back surface 192.

Geo-location 112 may include any type of device and method known in the art for determining geographic location information, including global positioning satellite (GPS), assisted GPS (AGPS), use of cellular towers or WiFi hotspots, etc. In certain instances, the location of a smart device may be referred to as a geo-location of a mobile electronic device. In certain instances, geo-location information may be entered into a user interface of a smart device. Mobile station assisted GPS is an example of a system determining the location of a handheld device using data received by the handheld device in calculations. This form of assisted GPS uses snapshot of GPS data received by the handheld device that is transmitted to (and received by) a system. Such a system using high quality GPS signals received by the system itself, can compare the fragments of GPS data from the handheld device and calculate a location. Similar location detection systems are common in the art. Frequently, these systems use information from cell towers when determining the location of a handheld device. Alternatively, the location of a Wi-Fi hotspot received by a handheld device may be used to determine an approximate location. Geographic location may be identified in terms of longitude and latitude coordinates, as a route, as a distance from a defined location, etc.

An accelerometer 116 is a sensor that is capable of detecting and/or measuring movement, disturbance, or shock to the user device 104. Accelerometer 116 may include any accelerometer or gyroscope known in the art. Accelerometer 116 could further be utilized to detect an orientation of the mobile device. Display objects or media could then be presented according to a detected orientation (e.g., portrait or landscape). When the accelerometer 116 is included within a smartphone 104, and the accelerometer detects a shock, the smartphone 104 may take a photo, a series of photos, or a take video clip. For example, the accelerometer 116 receives shock from a sound wave from an gunshot. At the moment, the report (shock wave) from the gunshot is received by the accelerometer 116, the smartphone 104 takes and stores a photo, as well as collects a measure of acceleration from the accelerometer 116.

Audio microphone 124 is a microphone for recording or inputting sound into user device 104. In certain instances, audio microphone 124 may further be used to capture a user's voice for communication via a telephone connection. Such an audio microphone 124 may be used to capture audio sounds from a surrounding environment.

Pressure 120 may be any sensor device or software known in the art for capturing or deriving information regarding pressure in a surrounding environment. Likewise, temperature 128 may be any sensor device or software known in the art for capturing or deriving information regarding temperature in a surrounding environment.

Applications 132 may include any number of software applications installed on the user device 104, including native applications (e.g., Notes, Messages, Camera, FaceTime, Weather, etc. on iPhone) and downloaded applications, which may include various social media applications (e.g., Facebook®, Twitter®, Instagram®).

Operating system (OS) 136 is a collection of software that manages computer hardware resources and provides common services for computer programs, including applications 132. The operating system 136 is an essential component of the system software in a computer system. Applications 132 are usually developed for a specific operation system 136 and therefore rely on the associated operating system 136 to perform its functions. For hardware functions such as input and output and memory allocation, the operating system 136 acts as an intermediary between applications 132 and the computer hardware. Although application code is usually executed directly by the hardware, applications 132 may frequently make a system call to an OS function or be interrupted by it. Operating systems 136 can be found on almost any device with computing or processing ability. Examples of popular modern operating systems include Android, BSD, iOS, Linux, OS X, QNX, Microsoft Windows, Windows Phone, and IBM z/OS. Most of these (except Windows, Windows Phone and z/OS) may share roots in UNIX.

Operating system 136 may comprise any number of stored files, as well as applications and settings related thereto. As such, operating system 136 may include audio files 140, camera management 144, communication 148, local storage 152, operating system settings 156, and state software 160.

Audio files 140 may include any type of audio file known in the art, including voicemail messages, recordings, music, and virtual assistant voice data. Camera management 144 may include any type of device or software known in the art for managing camera functions, as well as manipulating images (including video) taken with the camera. Communication 148

Local storage 152 may be a database that stores a user's settings related to how the user prefers user device 104 to operate, as well as information generated at the user device 104. Local storage 152 may be an organized collection of data, which may be typically organized to model relevant aspects of reality in a way that supports processes requiring this information.

Operating system settings 156 may be a software function that opens a display that lists OS functions that may be generated upon selection of a user interface button. Such a list of OS functions may be associated with various options that allow the user to designate certain preferences or settings with respect to how certain operating system functions are performed (e.g., display preferences, wireless network preferences, information sharing, accessibility of applications to system information, such as GPS/location, notifications). Once these settings 156 are set, the operating system 136 uses the settings 156 to perform various functions, which includes functions related to execution of an application 132.

State software 160 may include any type of device or software known in the art for determining a state of the user device 104.

Front-facing camera 164 may be a camera for capturing still images or video from the front side of the user device. In certain instances, the front camera 164 may be used to capture an image or video of the user (e.g., when participating in a video communication service like FaceTime™).

Communication antenna 168 may be an antenna that allows user device 104 to communicate wirelessly over the communication network 200. Such antenna 168 may communicate over WiFi, 4G/3G, Bluetooth, and/or any other known radio frequency communication network known in the art.

ON/OFF (or home) switch 172 may be a switch to turn the user device on or off or to return to a home screen. In certain instances, the ON/OFF (or home) switch 172 is a hardware button on the front surface of user device 104.

Back surface 192 of user device 104 may include a backward-facing camera, which may further be associated with a camera flash.

In certain embodiments of the present invention, a user interface may be displayed on a local display of a user's electronic device 104. The user's electronic device 104 may then receive a selection of a management control function through the local user interface. The first selection can restrict or allow the initiation of operations on the user's electronic device 104. The user of the electronic device 104 may change settings 156 relating to the management control function based on the user's preferences, and the electronic device 104 may receive and store those settings 156. When those settings 156 are implemented in part or entirely in the operating system (OS) 136 of the electronic device 104, an external electronic device communicating with the user's electronic device 104 may have difficulty hacking into and changing those OS settings 156. Camera management, thus, may provide increased functionality and increased security that are not currently available in the marketplace.

Settings set by the user of the mobile electronic device 104 may be used to identify metadata that will be collected by the mobile electronic device 104 when an image is received by a camera in the mobile electronic device 104. Images received by the camera may include photos, a series of photos, a video clip, or a series of video clips. The images may be captured by the camera using a CCD imaging device in the camera of the mobile electronic device 104.

Metadata collected by the mobile electronic device include, yet are not limited to, the state of the mobile electronic device, a measure of acceleration from an accelerometer, a geo-location, a temperature, a pressure, an audio sound, an audio recording, an audio file, a link to a URL, and a link to an online application. The state of the mobile electronic device may include information regarding configurations, settings, capabilities, and resources that are available on the mobile electronic device.

In certain instances, the mobile electronic device is aware of its geo-location when a video is recorded. When geo-location is enabled in the advanced camera settings of the mobile electronic device, the mobile electronic collects and stores the geo-location as metadata associated with a photo or video. In other instances environmental factors such as temperature or pressure may be included with metadata associated with an acquired photo or a video.

Similarly, an audio sound, an audio recording, or an audio file may be saved as metadata associated with a photo or a video. For example, a sound may be the sound of a bell that indicates the beginning of a lecture that is associated with a photo of a lecture hall. The photo could be referenced later to determine which students were present at the beginning of the lecture.

In another example, an audio recording may be included in metadata of a photo. In this instance, the audio recording could be the singing of happy birthday to a child, and the photo could be a photo of the child blowing out candles on a birthday cake. Similarly, an audio file of a pre-recorded greeting could be appended to the photo from the child's grandparents who were remotely viewing photos of the celebration.

An image may also be associated with a link to a URL or a link to an online application. In these instances, images may be uploaded to the URL or to the online application after the image is acquired. In certain other instances, images with URL or online application metadata may be or be transmitted in real-time to a remote electronic device on the Internet. Information relating to the URL link information and the link to the online application may also be included in metadata stored with the image.

Web database 176, third party apps 180, real-time storage 184, and real-time add-ins 188 may include any type of database, storage device, etc., that may include or be associated with any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Alternatively, different functionalities may be allocated among multiple servers, which may be located remotely from each other and communicate over the cloud. Any of the aforementioned servers (or an integrated server) may take on certain client-side, cache, or proxy server characteristics. These characteristics may depend on the particular network placement of the server or certain configurations of the server.

Web database 176 may be any type of web, internet, or cloud storage known in the art. Third party apps 180 may store any number and type of third party applications for camera management. Real-time storage 184 may store any type of camera data, including images, associated metadata, etc. from a number of users.

Real-time add-ins 188 are software functions that may be downloaded and uses by user device 104. In certain instances, real-time add-ins 188 provide a weather forecast relating to a geo-location where user device 104 is currently located. Other examples of functionality that may be provided by a real-time add-in 188 are pricing information from a store that a user of user device 104 is currently visiting.

Data relating to geo-location or data from one or more sensors may be stored as metadata that is associated with image data collected by smart device 104. In certain instances, image data and metadata may be stored in local storage resident on user device 104 or in an external electronic device such as web data base 176, a storage location managed by third party application 180, or real-time storage 184. Image data consistent with the invention may comprise data from any form of still or video images captured by a smart device.

Cloud or Internet communication network 200 allow for communication between the user device 104 and other devices via various communication paths or channels 194, 204A-C, and 208. Such paths or channels may include any type of data communication link known in the art, including TCP/IP connections and Internet connections via Wi-Fi, Bluetooth, UMTS, etc. In that regard, communications network 200 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider.

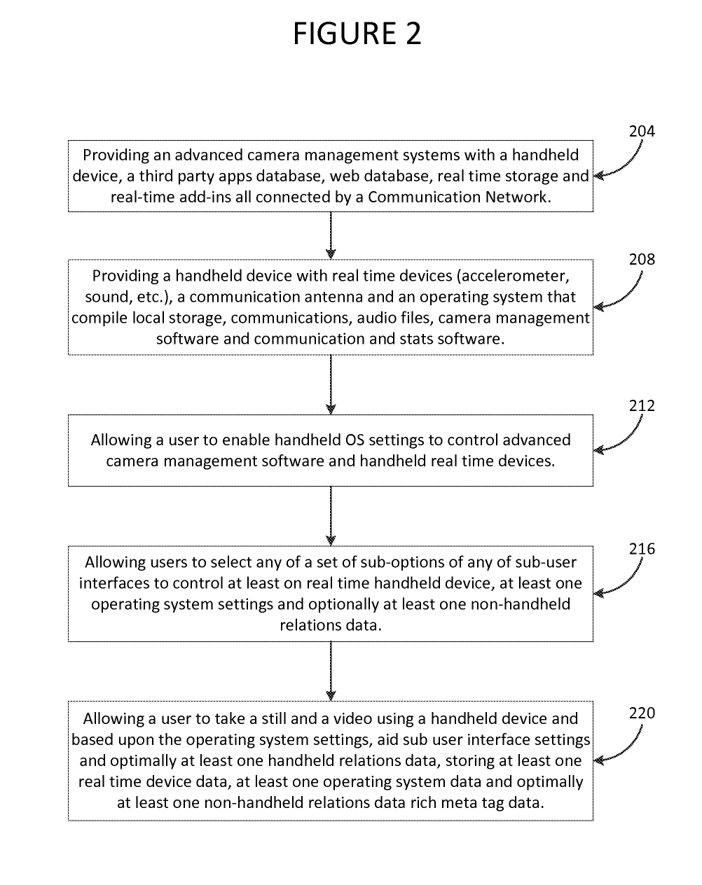

FIG. 2 is a flowchart illustrating an exemplary method 200 for advanced camera management. In step 204, an advanced camera management system is provided, which includes a handheld devices (e.g., smart device 104), third party application database, a web database, real-time storage, and real-time add-ins. Each of the aforementioned devices may be connected to the cloud through various communication paths.

In step 208, a handheld device may be provided with real-time sensor devices, (e.g., accelerometer), a communication antenna, and an operating system. The handheld device may further include local storage, communications, audio files, camera management software, communication software, and state software.

In step 212, a user of the handheld device may enable OS settings that control advanced camera management software, and real-time support in the handheld device. The user may enable or disable one or more settings through a user interface displayed on the display of a smartphone. Furthermore, in certain instances, these settings may be adjusted using a touchscreen.

In step 216, a user of a handheld device is allowed to select a set of sub-options on a plurality of sub-user interfaces. These sub-user interfaces may control real-time functions, and operating system settings. Optionally, these sub-user interfaces allow a user to configure relationships between data collected by a handheld device to be related to a function or feature that that is not related to the handheld device itself. For example, features or functions not related to the handheld device itself, real-time video, and associated metadata may be stored in the real-time storage database 184.

Real-time data may be any data that corresponds to the time when a photo or video was acquired by a smart device. In certain instances, real-time data may include a video stream uploaded to a data storage device on the internet. In other instances, real-time data may be information downloaded onto a user device relating to the geo-location where a photo was taken.

In step 220, a user of a handheld device is allowed to take a still photo or a video. User-configured settings may be used to store real-time data collected by the device. In certain instances, such data may include operating system data and metadata associated with the still photo and the video. In certain instances, the metadata associated with an image may be stored in a different location than the location where the image data is stored.

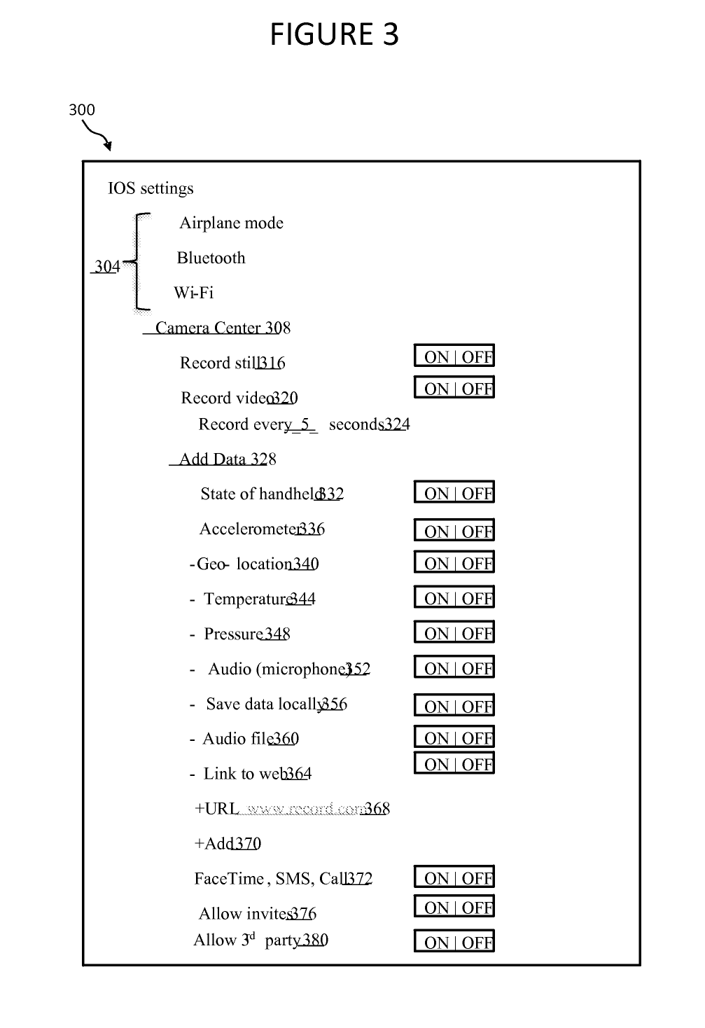

FIG. 3 illustrates exemplary camera center settings 300 of a mobile device that may be used in a system for advanced camera management.

The user interface in the figure is referred to as camera center 300. Camera center settings 300 may include standard iOS settings 304 (e.g., airplane mode, Bluetooth, and Wi-Fi). Each of these may open a sub-menu when one of these standard I=iOS settings are selected in the user interface. Camera center-specific settings 308 may include record still photo 316, record video 320, record every 5 seconds 324, and add data 328. Record still photo 316, record video 320, and record every 5 seconds 324 are settings controlling how images are captured, as well as how often. As illustrated, each option may be enabled or disabled via an on/off selection box. For example, the on/off selection box associated with the record still 316 allows a user to enable or disable the recording of a still photo taken by a camera in a smartphone.

The add data 328 option may allow for a variety of different types of data to be detected in real-time as an image is captured. Such data (which may pertain to the circumstances and environment in which the image was taken) may then be associated with the image as metadata. Such metadata may relate to a current state of handheld 332, accelerometer 336, a geo-location 340, a temperature 344, a pressure 348, an audio (microphone) 352 recording, save data locally 356, pre-recorded audio file 360, link to web 364 via adding a URL 368 (e.g., record.com), software applications such as FaceTime, SMS, or Call 372, allow invites 376, or allow 3rd party 380 applications to have access to image data.

Store data locally 356 allows a user to save photos and videos with associated metadata locally. Alternatively, another setting may allow for storage on a remote system. The setting for +add 370 allows a user to add webpages that may be linked to under the link to web 364 selection box.

Applications such as FaceTime, SMS, and Call 372 may be used to share image data in real-time with the selected applications. Allow invites 376 is a setting that allows other devices to view image data and associated metadata while a photo or video is being captured. In certain instances, 3rd party 380 selection box allows applications created by others to access and manipulate images and associated metadata collected by smart device 104.

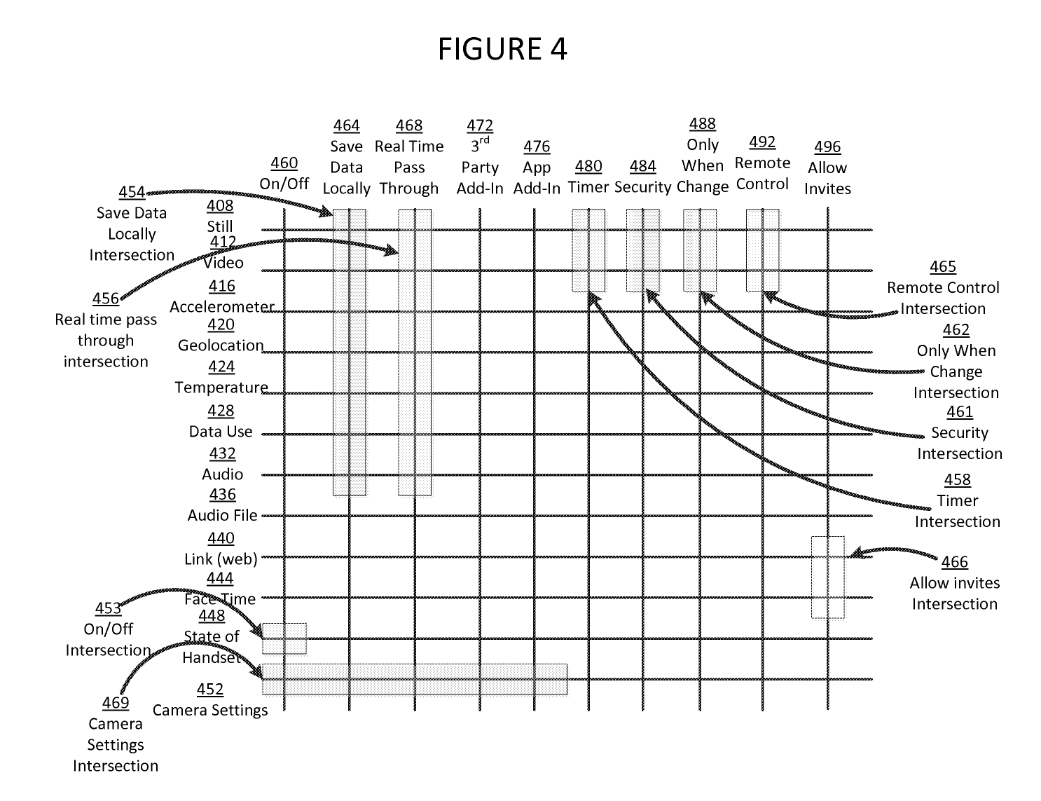

FIG. 4 is a chart illustrating exemplary metadata camera controls that may be implemented via a system for advanced camera management. Each individual metadata camera control may be associated (e.g., at intersections) with any of a series of functions with metadata. Individual metadata camera controls in the figure may include still 408, video 412, accelerometer 416, geo-location 420, temperature 424, data use 428, audio 432, audio file 436, link (WEB) 440, FaceTime 444, state of handset 448, and camera settings 452. Functions with metadata may include on/off 460, save data locally 464, real-time pass through 468, 3^{rd} party add-in 472, application add-in 476, timer 480, security 484, only when change, remote control 492, and allow invites 496. Intersections between metadata camera controls and functions with metadata identify selected sets of metadata that may be recorded with an image that image is saved. On/off intersection 453, for example, indicates whether the particular device, sensor, or function (e.g., state of handset 448) may be turned on or off.

Save data locally intersection 454 identifies various types of metadata that may be enabled for inclusion in image-associated metadata stored locally on user device 104. Save data locally intersection 454 indicates that metadata relating to an accelerometer 416, geo-location 420, temperature 424, amount of data use 428, an audio 436 recording may be stored locally when still 408 or image video 412 data is stored locally. Data use 428 may include metadata that relates an amount of data used by the phone when transmitting image and metadata over a 3G, or a 3G/LTE communication connection.

Real-time pass through intersection 456 identifies types of metadata that may be stored with associated image data locally on a user device. As illustrated, still 408 and video 412 data may be stored including metadata relating to the accelerometer 416, geo-location 420, temperature 424, amount of data use 428, and audio 432.

Timer intersection 458 links timer 480 settings to still 408 and video 412 image data. Timer 480 allows a photo to be taken for every 5 seconds when the timer function 480 is set to record a photo every 5 seconds 324. Security intersection 461 links still 408 and video 412 data to a security function. In certain instances, security functions may include usernames and passcodes. In other instances, a security function includes an encryption function.

Only when change intersection 462 links still 408 and video 412 data to a change of state. A change in state may be associated with any camera control function set by a user of a user device. Examples of a change include, yet are not limited to, changes in temperature, shock events detected by an accelerometer, and changes in a geo-location. A change in state may be any trigger event associated with the acquisition of a photo or a video when a pre-identified change of state is detected by a smart device. Remote control intersection 465 may intersect with still 408 photos and video 412, indicating that a photo or a video will be acquired when a remote control 492 command is received by smart device 104.

Camera setting intersection 469 indicates various means by which camera settings may be configured, including being turned on or off, storing data locally, passing through in real-time to another device, allowing 3rd party applications add-ins to interact with image data acquired by a smart device, and that application add-ins may be used.

In certain instances, third party add-ins allow application programs created by third parties to access and manipulate photos, images, and associated metadata. In certain instances, a 3rd party add-ins enable a 3rd party to an view image and its associated metadata. In certain other instances, 3rd party add-ins enable a 3rd part to associate metadata from an image with other images that contain similar metadata.

Similarly, application add-ins allow application programs created by an original vendor to access and manipulate photos, images, and associated metadata. In certain instances, an application add-ins enable an original application program to view an image and its associated metadata. In certain other instances, this setting allows an original application program used to associate metadata from a first image with other images that contain similar metadata.

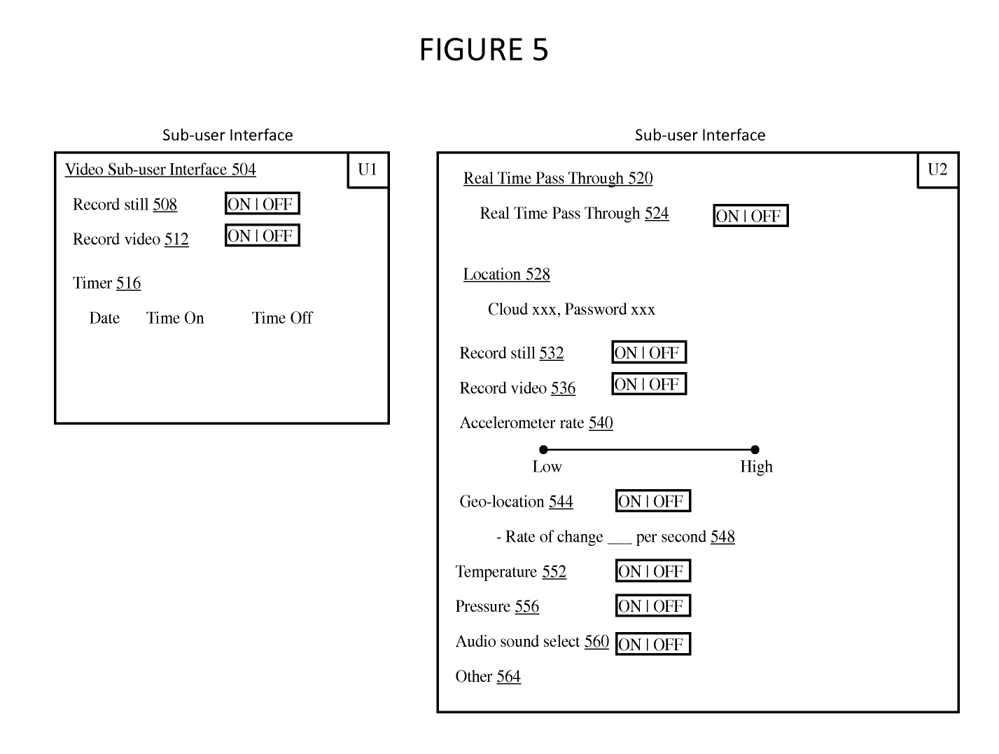

FIG. 5 illustrates an exemplary video sub-user interface 504 and an exemplary real time sub-user interface 520 that may be used in a system for advanced camera management. Video sub-user interface 504 may include record still 508, record video 512, and timer 516. Timer 516 allows timer metadata to be stored with a still image 508 or with a video 512. Metadata associated with timer 516 may include the time at which a photo or video was taken. In other instances, the metadata associated with timer 516 may further include the date a video was taken, the time when a video began (“time on”), and the time when a video ended (“time off”).

Real-time pass through 520 sub-user interface may include real-time pass through 524, location 528, record still 532, record video 536, accelerometer rate 540, geo-location 544, rate of change _ per second 548, temperature 552, pressure 556, audio sound select 560, and other 564.

Location 528 identifies that the real-time data should be passed through to cloud xxx, using password xxx. A slide-selection in the figure allows accelerometer rate 540 to be continuously adjusted from a low to a high value.

Rate of change _ per second 548 is setting where a user may enter a value for collecting metadata per unit of time. For example, data from an accelerometer may be collected 4 times per second when the rate of change is set to 4 (samples) per second.

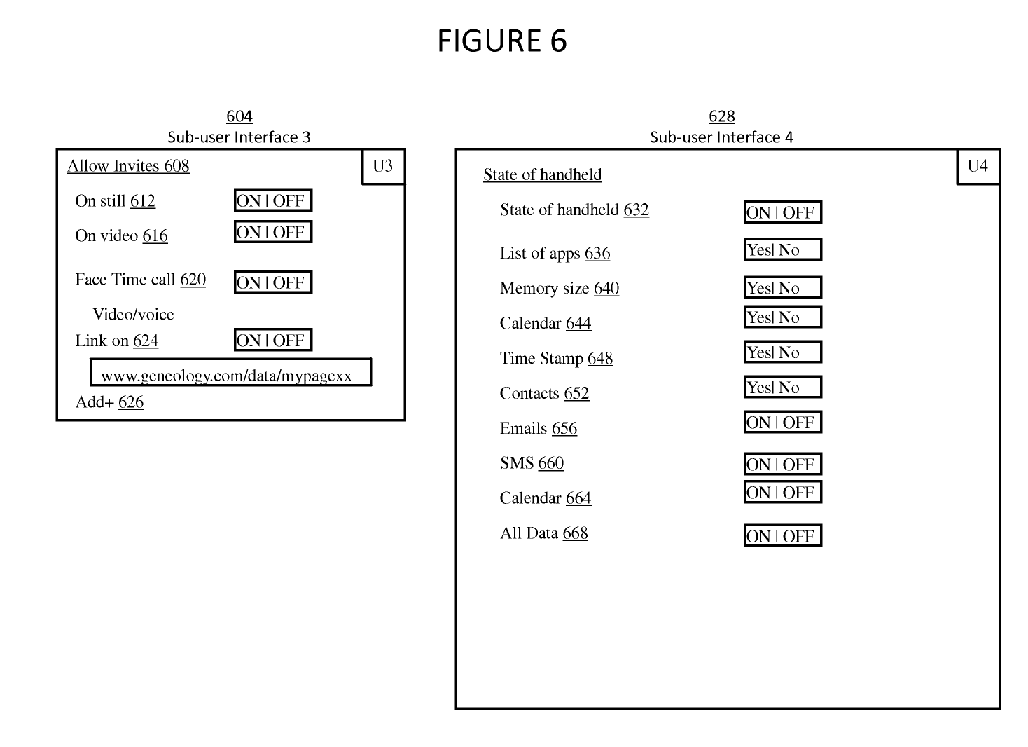

FIG. 6 illustrates an exemplary allow invites 608 sub-user interface 604 and an exemplary state of handheld 628 sub-user interface that may be used in a system for advanced camera management. Sub-user interface 3 604 allows a user to configure settings relating to allowing invites 608, including options for capturing on still 612, on video 616, FaceTime call 620, link on 624, and others to be added 626. These on/off boxes allow each of these functions to be enabled or disabled.

On still 612 and on video 616 allow invited users of other smart devices to view photos or videos. In certain instances, FaceTime call 620 enables video from a cell phone to be linked to the Apple FaceTime application in a FaceTime call. In other instances, add link on 624 allows photos to be uploaded to a location on the geneology.com website. The function add+ 626 allows additional URLs to be added to the link on 624 function, thus allowing image data and associated metadata to be uploaded to numerous websites.

Sub-user interface 4 628 may include options for capturing metadata regarding state of handheld 632, list of applications 636, memory size 640, calendar 644, time stamp 648, contacts 652, emails 656, SMS 660, calendar, and all data 668. State of handheld 632 allows metadata relating to the current activity and status of a smartphone to be saved as metadata. List of applications 636 is a setting that allows applications that are currently running on the device to interact with image data and metadata acquired by a smart device. Memory size 640 allows the amount of memory currently available on a smart device to be collected by a smart device or to be collected by an external electronic device. Calendar 644 allows information related to scheduled events to be accessed by a smart device. Time stamp 648 allows the recording of a time stamp relating to when a photo or video were taken. Contacts 652 and Emails 656 allows the collection of contacts listed in the smart device to be collected when a photo is taken. SMS 660 allows information relating to text messages to be collected by a smart device. All data 668 is a setting that allows all data about all possible information to be collected by or from a smart device.

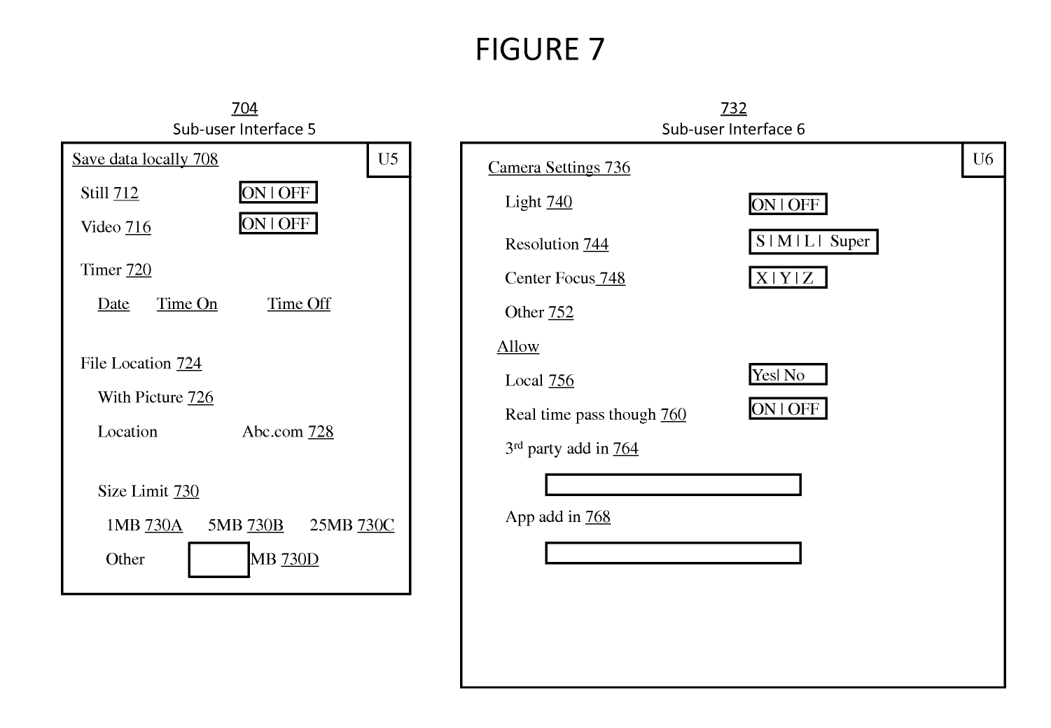

FIG. 7 illustrates an exemplary save data locally 708 sub-user interface 704 and an exemplary camera settings 736 sub-user interface 732 that may be used in a system for advanced camera management. Sub-user interface 5 704 may include options for saving still 712, video 716, timer 720, file location 724, with picture 726, location 728 (e.g., abc.com), and size limit 730 (e.g., selected from size options 1 MB 730A, 5 MB 730B, 25 MB 730C, and other to be entered 730D).

Time 720 may be a timer setting that allows the time at which a still photo or a video was acquired to be stored locally on a smart device as metadata in associated with the image. In certain instances, timer 720 includes a date, a time on, and a time off.

File location 724 allows a user to identify where to store metadata that is associated specific image or video data. In certain instances, metadata may be stored with picture 726 data. In other instances, metadata may be stored in a separate location from the picture data that is associated with. location abc.com 728, which may identify an external location relating to where metadata or image data may be stored.

Size limit 730 may include includes 1 MB 730A, 5 MB 730B, 25 MB 730C, and other MB 730D. Size limit 730 allows the user to select or to set a maximum size of metadata that will be stored for an associated photo or video.

Sub user interface 6 732 includes sub-menu camera settings 736, which may allow a user to set settings to illuminate light 740 or flash, adjust the resolution 744 of a photo, select a center focus 748 point (X, Y, Z), and other camera settings to be added 752. Sub user interface 6 732 may further allow local 756 storage of camera of settings data on a smart device and real-time pass through 760 to allow camera settings to be passed through to the cloud. Additionally, 3rd party add-in 764 enables camera control settings to be controlled by a 3rd party application, and application add-in 768 allows local applications to control camera control settings.

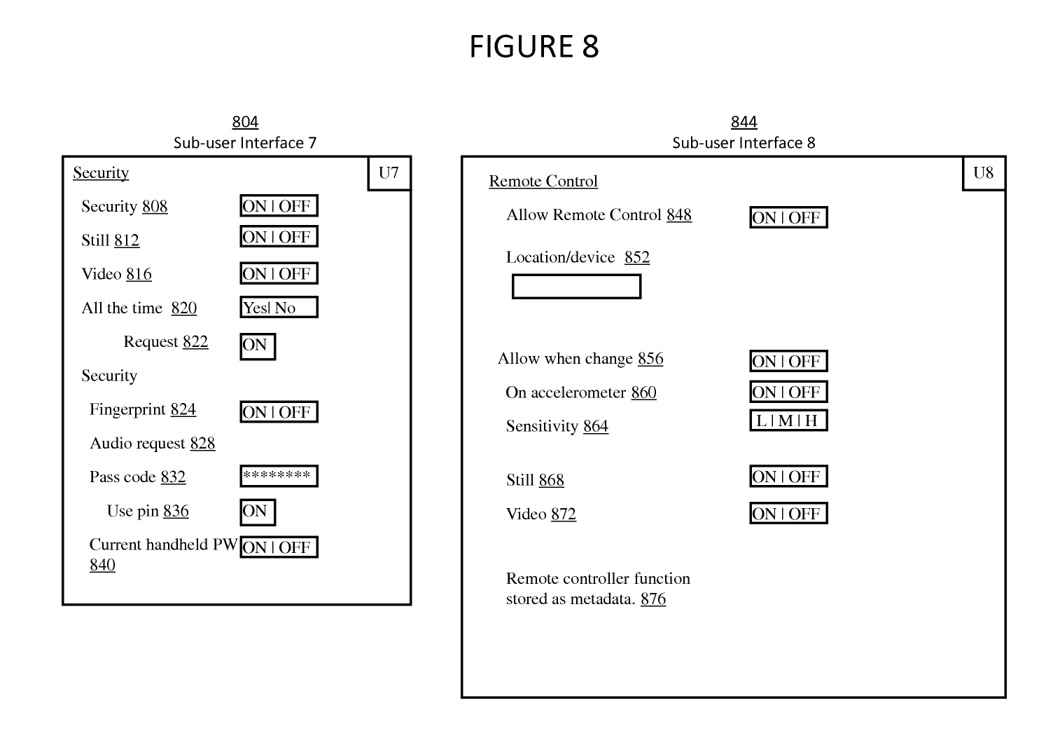

FIG. 8 illustrates an exemplary security sub-user interface 804 and an exemplary remote sub-user interface 844 that may be used in a system for advanced camera management. Sub-user interface 7 804 includes various settings that relate to security. Security 808 allows security functions to be enabled or disabled using an on/off selection box. Security options may be applied to still 812 and video 816, as well as how often to apply such security options. The user may opt to have them applied all the time 820 or upon request 822. The user may also provide different types of security measures, including fingerprint 824, audio request 828, pass code 832, use pin 836, and current handheld password 840.

Finger print 824 and audio request 828 are both biometric security settings that when enabled, respectively require a fingerprint or an audio biometric to be entered into and matched by a smart device to pre-recorded biometrics. In certain instances, a biometric must be entered and matched before access to image data or metadata associated with the image will be allowed. Pass code 832 is an option to require that a specific pass code be entered into the smart device before allowing access to a secured function on the smart device. Use pin 836, when enabled, sets the smart phone to require that a personal identification number be entered before allowing access to a secured function on the smart device. Current handheld password 840 is an option for using a current password of the handheld device to allow access to a secured function on the smart device.

Sub-user interface 8 844 includes a series of remote control functions on a smart device. Allow remote control 848 enables or disables remote control the camera of the smart device. Location/device 852 allows a user to enable a specific smartphone, Bluetooth device, or Wi-Fi device to remotely control the camera of the smart device. Allow when change 856 and on accelerometer 860 are settings that enable or disable a camera function when triggered by a change 856 sensed by the smart device (e.g., when the accelerometer triggers a shock event).

Sensitivity 864 is a setting that sets the sensitivity of a setting in the smart device to sense something (e.g., change, motion, shock event, etc.). Sensitivity settings depicted include low, medium, and high sensitivity.

Video 872 on/off selection box allows a video to be taken via remote control. Remote controller function stored as metadata 876 is a setting that allows the remote control settings of a user device to be stored as metadata when a photo or when a video is taken.

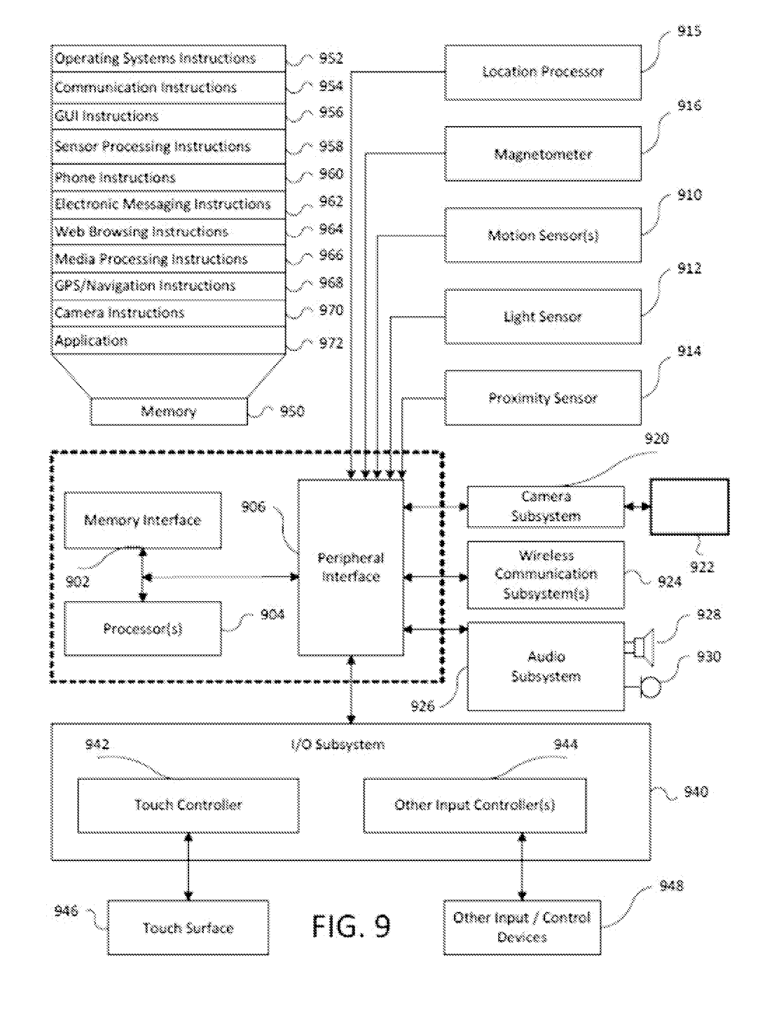

FIG. 9 illustrates a mobile device architecture that may be utilized to implement the various features and processes described herein. Architecture 900 can be implemented in any number of portable devices including but not limited to smart phones, electronic tablets, and gaming devices. Architecture 900 as illustrated in FIG. 9 includes memory interface 902, processors 904, and peripheral interface 906. Memory interface 902, processors 904 and peripherals interface 906 can be separate components or can be integrated as a part of one or more integrated circuits. The various components can be coupled by one or more communication buses or signal lines.

Processors 904 as illustrated in FIG. 9 are meant to be inclusive of data processors, image processors, central processing unit, or any variety of multi-core processing devices. Any variety of sensors, external devices, and external subsystems can be coupled to peripherals interface 906 to facilitate any number of functionalities within the architecture 900 of the exemplar mobile device. For example, motion sensor 910, light sensor 912, and proximity sensor 914 can be coupled to peripherals interface 906 to facilitate orientation, lighting, and proximity functions of the mobile device. For example, light sensor 912 could be utilized to facilitate adjusting the brightness of touch surface 946. Motion sensor 910, which could be exemplified in the context of an accelerometer or gyroscope, could be utilized to detect movement and orientation of the mobile device. Display objects or media could then be presented according to a detected orientation (e.g., portrait or landscape).

Other sensors could be coupled to peripherals interface 906, such as a temperature sensor, a biometric sensor, or other sensing device to facilitate corresponding functionalities. Location processor 915 (e.g., a global positioning transceiver) can be coupled to peripherals interface 906 to allow for generation of geo-location data thereby facilitating geo-positioning. An electronic magnetometer 916 such as an integrated circuit chip could in turn be connected to peripherals interface 906 to provide data related to the direction of true magnetic North whereby the mobile device could enjoy compass or directional functionality. Camera subsystem 920 and an optical sensor 922 such as a charged coupled device (CCD) or a complementary metal-oxide semiconductor (CMOS) optical sensor can facilitate camera functions such as recording photographs and video clips.

Communication functionality can be facilitated through one or more communication subsystems 924, which may include one or more wireless communication subsystems. Wireless communication subsystems 924 can include 802.5 or Bluetooth transceivers as well as optical transceivers such as infrared. Wired communication system can include a port device such as a Universal Serial Bus (USB) port or some other wired port connection that can be used to establish a wired coupling to other computing devices such as network access devices, personal computers, printers, displays, or other processing devices capable of receiving or transmitting data. The specific design and implementation of communication subsystem 924 may depend on the communication network or medium over which the device is intended to operate. For example, a device may include wireless communication subsystem designed to operate over a global system for mobile communications (GSM) network, a GPRS network, an enhanced data GSM environment (EDGE) network, 802.5 communication networks, code division multiple access (CDMA) networks, or Bluetooth networks. Communication subsystem 924 may include hosting protocols such that the device may be configured as a base station for other wireless devices. Communication subsystems can also allow the device to synchronize with a host device using one or more protocols such as TCP/IP, HTTP, or UDP.

Audio subsystem 926 can be coupled to a speaker 928 and one or more microphones 930 to facilitate voice-enabled functions. These functions might include voice recognition, voice replication, or digital recording. Audio subsystem 926 in conjunction may also encompass traditional telephony functions.

I/O subsystem 940 may include touch controller 942 and/or other input controller(s) 944. Touch controller 942 can be coupled to a touch surface 946. Touch surface 946 and touch controller 942 may detect contact and movement or break thereof using any of a number of touch sensitivity technologies, including but not limited to capacitive, resistive, infrared, or surface acoustic wave technologies. Other proximity sensor arrays or elements for determining one or more points of contact with touch surface 946 may likewise be utilized. In one implementation, touch surface 946 can display virtual or soft buttons and a virtual keyboard, which can be used as an input/output device by the user.

Other input controllers 944 can be coupled to other input/control devices 948 such as one or more buttons, rocker switches, thumb-wheels, infrared ports, USB ports, and/or a pointer device such as a stylus. The one or more buttons (not shown) can include an up/down button for volume control of speaker 928 and/or microphone 930. In some implementations, device 900 can include the functionality of an audio and/or video playback or recording device and may include a pin connector for tethering to other devices.

Memory interface 902 can be coupled to memory 950. Memory 950 can include high-speed random access memory or non-volatile memory such as magnetic disk storage devices, optical storage devices, or flash memory. Memory 950 can store operating system 952, such as Darwin, RTXC, LINUX, UNIX, OS X, ANDROID, WINDOWS, or an embedded operating system such as VXWorks. Operating system 952 may include instructions for handling basic system services and for performing hardware dependent tasks. In some implementations, operating system 952 can include a kernel.

Memory 950 may also store communication instructions 954 to facilitate communicating with other mobile computing devices or servers. Communication instructions 954 can also be used to select an operational mode or communication medium for use by the device based on a geographic location, which could be obtained by the GPS/Navigation instructions 968. Memory 950 may include graphical user interface instructions 956 to facilitate graphic user interface processing such as the generation of an interface; sensor processing instructions 958 to facilitate sensor-related processing and functions; phone instructions 960 to facilitate phone-related processes and functions; electronic messaging instructions 962 to facilitate electronic-messaging related processes and functions; web browsing instructions 964 to facilitate web browsing-related processes and functions; media processing instructions 966 to facilitate media processing-related processes and functions; GPS/Navigation instructions 968 to facilitate GPS and navigation-related processes, camera instructions 970 to facilitate camera-related processes and functions; and instructions 972 for any other application that may be operating on or in conjunction with the mobile computing device. Memory 950 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 950 can include additional or fewer instructions. Furthermore, various functions of the mobile device may be implemented in hardware and/or in software, including in one or more signal processing and/or application specific integrated circuits.

Certain features may be implemented in a computer system that includes a back-end component, such as a data server, that includes a middleware component, such as an application server or an Internet server, or that includes a front-end component, such as a client computer having a graphical user interface or an Internet browser, or any combination of the foregoing. The components of the system can be connected by any form or medium of digital data communication such as a communication network. Some examples of communication networks include LAN, WAN and the computers and networks forming the Internet. The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an API that can define on or more parameters that are passed between a calling application and other software code such as an operating system, library routine, function that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer may employ to access functions supporting the API. In some implementations, an API call can report to an application the capabilities of a device running the application, such as input capability, output capability, processing capability, power capability, and communications capability.

Users may use any number of different electronic user devices, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network. User devices may also be configured to access data from other storage media, such as memory cards or disk drives as may be appropriate in the case of downloaded services. User device may include standard hardware computing components such as network and media interfaces, non-transitory computer-readable storage (memory), and processors for executing instructions that may be stored in memory.

The figures included with this disclosure are for the purpose of illustrating the invention. The figures show aspects of one or more embodiments of the invention and are examples, the figures are not meant to limit the scope of the invention. So it should be understood that the present invention is not limited to the precise arrangements and instrumentalities shown in the figures.

What is claimed is:

1. A method of advanced camera management in a mobile electronic device, the method comprising:
receiving an indication that a new image is captured by a camera, wherein the new image is automatically associated with metadata; and
executing an application stored in memory, wherein execution of the application by a processor:
detects information regarding an environment in which the new image was captured,
updates the metadata associated with the new image to include the detected information, wherein the metadata includes at least one of acceleration data sensed by a sensor, a universal resource locator (URL), or an amount of data associated with transmitting the new image over a wireless data communication interface,
retrieves stored information regarding a plurality of other images in memory, wherein each other image is associated with metadata, and
analyzes the new image and updated metadata to identify similarities with one or more of the stored images and associated metadata.

2. The method of claim 1, wherein the new image comprises at least one of a photo, a series of photos, a video clip, and a series of video clips.

3. The method of claim 1, wherein the detected information regarding the environment in which the new image was capture comprises at least one of the state of the mobile electronic device, a measure of acceleration from an accelerometer, a geo-location, a temperature, a pressure, an audio sound, an audio recording, an audio file, a link to a URL, and a link to an online application.

4. The method of claim 1, further comprising storing the new image and updated metadata in memory.

5. The method of claim 1, further comprising sending the new image and updated metadata to a remote electronic device for storage.

6. The method of claim 1, wherein identifying similarities comprises identifying other images of interest to the user, and further comprising generating a notification to the user regarding the identified other images of interest.

7. The method of claim 1, wherein identifying similarities comprises identifying a trend characterizing the new image and one or more of the stored images, and further comprising generating a notification to the user regarding the identified trend.

8. The method of claim 7, further comprising associating images identified as similar and re-creating a visual experience based on the associated images identified as similar.

9. An apparatus of advanced camera management in a mobile electronic device, the apparatus comprising:
a camera that provides an indication when a new image is captured, wherein the new image is automatically associated with metadata; and
a processor that executes an application stored in memory, wherein execution of the application by a processor:
detects information regarding an environment in which the new image was captured,
updates the metadata associated with the new image to include the detected information, wherein the metadata includes at least one of acceleration data sensed by a sensor, a universal resource locator (URL), or an amount of data associated with transmitting the new image over a wireless data communication interface,
retrieves stored information regarding a plurality of other images in memory, wherein each other image is associated with metadata, and
analyzes the new image and updated metadata to identify similarities with one or more of the stored images and associated metadata.

10. The apparatus of claim 9, wherein the new image comprises at least one of a photo, a series of photos, a video clip, and a series of video clips.

11. The apparatus of claim 9, wherein the detected information regarding the environment in which the new image was capture comprises at least one of the state of the mobile electronic device, a measure of acceleration from an accelerometer, a geo-location, a temperature, a pressure, an audio sound, an audio recording, an audio file, a link to a URL, and a link to an online application.

12. The apparatus of claim 9, further comprising memory that stores the new image and updated metadata.

13. The apparatus of claim 9, further comprising a communication interface that sends the new image and updated metadata to a remote electronic device for storage.

14. The apparatus of claim 9, wherein identifying similarities comprises identifying other images of interest to the user, and further comprising a display screen that displays a generated notification to the user regarding the identified other images of interest.

15. The apparatus of claim 9, wherein identifying similarities comprises identifying a trend characterizing the new image and one or more of the stored images, and further comprising a display screen that displays a generated notification to the user regarding the identified trend.

16. The apparatus of claim 15, wherein the processor executes a simulator to associate images identified as similar and to re-create a visual experience based on the associated images identified as similar.

17. A non-transitory computer readable storage medium having embodied therein a program executable by a processor to perform a method of advanced camera management in a mobile electronic device, the method comprising:
receiving an indication that a new image is captured by a camera, wherein the new image is automatically associated with metadata;
detecting information regarding an environment in which the new image was captured;
updating the metadata associated with the new image to include the detected information, wherein the metadata includes at least one of acceleration data sensed by a sensor, a universal resource locator (URL), or an amount of data associated with transmitting the new image over a wireless data communication interface;
retrieving stored information regarding a plurality of other images in memory, wherein each other image is associated with metadata; and
analyzing the new image and updated metadata to identify similarities with one or more of the stored images and associated metadata.
